(19) United States
(12) Patent Application Publication
(10) Pub. No.: US 2010/0226507 A1
(43) Pub. Date: Sep. 9, 2010

(54) Microphone Unit

(75) Inventors: Ryusuke HORIBE, Daito-shi (JP); Rikuo Takano, Daito-shi (JP); Fuminori Tanaka, Daito-shi (JP); Takeshi Inoda, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/716,470

(22) Filed: Mar. 3, 2010

(30) Foreign Application Priority Data
Mar. 3, 2009 (JP) 2009-049921

(51) Int. Cl. H04R 3/00

(52) U.S. Cl. 381/92

(57) ABSTRACT

A microphone unit comprises first and second microphones and a delay element. When sound is input to the first and second microphones, the delay element delays an output signal of the first microphone so as to detect the sound by a difference signal between the output signal of the first microphone and an output signal of the second microphone. The delay element delays the output signal of the first microphone so as to satisfy relation 0.76≦D/Δr≦2.0 where D is amount of delay for the output signal of the first microphone while Δr is distance between the first and second microphones. The relation D/Δr≦2.0 can reduce far-field noise, while the relation 0.76≦D/Δr can increase the detection sensitivity to sound emitted from a null point.

### BACKGROUND OF THE INVENTION

1. Field of the Invention

The present invention relates to a microphone unit which detects sound (i.e. vibration of air) and converts the detected sound to an electrical signal as an output signal.

2. Description of the Related Art

A microphone unit is known which has a first microphone and a second microphone for receiving input sound and converting the received sound to electrical signals as output signals, respectively, so as to detect the sound by a difference between the output signal of the first microphone and that of the second microphone. It is a kind of differential type microphone unit, and has a figure “8” shaped bi-directional characteristics (pattern). Such a microphone unit has an effect to reduce far-field noise (reduce detection sensitivity to detect sound emitted from a far position) as compared with a non-directional (omni-directional) microphone unit which detects sound by an output signal of a single microphone.

FIG. 12 is a graph showing relationship between sound source distance (position from which the sound is emitted) and detection sensitivity in a differential type microphone unit and a non-directional microphone unit. As apparent from the relationship shown in FIG. 12, the difference between the detection sensitivity to sound emitted from a near position and that emitted from a far position (reduction degree of detection sensitivity to sound emitted from a far position relative to that emitted from a near position) is larger in the case of the differential type microphone than in the case of the non-directional microphone. It can be understood from this that the differential type microphone unit has an effect to reduce far-field noise as compared with the non-directional microphone unit.

Now considering positions from which sound is emitted (positions of the sound source) in the conventional differential type microphone unit, there exits a position where the phase of an output signal of the first microphone is equal to that of the second microphone. Such a position is referred to as a null point. In the conventional differential type microphone unit, the null point is formed at a position where the sound propagation time from the sound source to the first microphone is equal to that to the second microphone, namely at a position where the distance from the sound source to the first microphone is equal to that to the second microphone. Thus, in the conventional differential type microphone unit, sound emitted from the null point causes a sound wave input to the first microphone to be equal to that to the second microphone both in phase and amplitude, making an output signal from the first microphone equal to that from the second microphone both in phase and amplitude. Thus, the sound emitted from the null point causes the output signals of the first and second microphone to have no difference, resulting in a zero detection output for the sound emitted from the null point.

When mounted in a product such as a mobile phone, the conventional differential type microphone has an advantage that it can receive a voice of a close talker (user) and reduce far-field noise. However, there is a problem that if the mouth of the talker (user) is positioned at a null point, the voice (sound) of the talker is significantly reduced in level, making it impossible to recognize the talking voice. This is particularly so in a mobile phone 90 shown in FIG. 13 which is a schematic front view showing an example of mounting a conventional differential type microphone unit 80 in the mobile phone 90. Referring to FIG. 13, the mobile phone 90 has sound receiving openings 92a, 92b formed on one side thereof, while the differential type microphone unit 80 has first and second microphones 81a, 81b with sound receiving portions 82a, 82b, respectively, which face the sound receiving openings 92a, 92b, respectively, and are placed on the same side on which the sound receiving openings 92a, 92b are placed. Such an arrangement is likely to cause a problem described above, preventing good voice quality.

There are other known microphone units in the art. For example, Japanese Laid-open Patent Publication 2007-180896 discloses a sound (audio) signal processing device with a bi-directional microphone (first microphone) and a non-directional microphone (second microphone) placed close to each other, in which output signals of the first and second microphones are processed to extract therefrom a signal having a predetermined correlation so as to allow the directional characteristics to be high in a narrow angular range. Japanese Patent 3620133 discloses a stereo microphone having four microphone capsules, in which output signals of the four microphone capsules are processed to obtain a stereo sound (audio) signal.

Japanese Laid-open Patent Publication 2003-44087 discloses an ambient noise reduction system with multiple microphones, in which input signals of the microphones are processed to subtract therefrom sound (audio) signals so as to estimate an ambient noise signal from the remaining signal after subtraction. A spectrum of the ambient noise signal is subtracted from a spectrum component of the input signals so as to reduce the ambient noise signal. Japanese Laid-open Patent Publication Hei 5-284588 discloses a sound (audio) signal input device having first and second microphones, in which an output signal of the second microphone is delayed and then phase-reversed. The thus phase-reversed output signal of the second microphone and the output signal of the first microphone are summed and amplified so as to cancel ambient noise. Further, Published Japanese Translation of PCT Application No. 2002-507334 discloses a noise control device having a curved reflector to deflect ambient noise so as to eliminate ambient noise. However, these known devices or systems do not solve the above problem.

### SUMMARY OF THE INVENTION

An object of the present invention is to provide a microphone unit which can increase the detection sensitivity to sound emitted from a null point while reducing far-field noise.

According to the present invention, this object is achieved by a microphone unit comprising: a first microphone and a second microphone for converting sound to electrical signals as output signals so as to detect the sound based on the output signals of the first and second microphones; and delay means for delaying the output signal of the first microphone. The delay means delays the output signal of the first microphone so as to satisfy relation 0.76≦D/Δr≦2.0 where D is amount of delay for the output signal of the first microphone while Δr is distance between the first and second microphones. Further, the sound is detected by a difference signal between the output signal of the first microphone delayed by the delay means and the output signal of the second microphone.

The microphone unit of the present invention delays the output signal of the first microphone so as to position a null point at such a position that the distances therefrom to the first and second microphones are different from each other. This causes the amplitude of the sound input to the first microphone to be different from that input to the second microphone. Consequently, the output signals of the first and second microphones based on the sound emitted from the null point are different in amplitude from each other. This difference in amplitude between the output signals of the first and second microphones based on the sound emitted from the null point occurs even if the two output signals are equal to each other in phase. Thus, the sound emitted from the null point causes the difference between the two output signals, preventing zero detection output for the sound emitted from the null point, so that the sound emitted from the null point can be detected by using this difference between the two output signals.

In addition, the output signal of the first microphone is delayed by an amount of delay D which satisfies the relation 0.76≦D/Δr≦2.0 where Δr is distance between the first and second microphones. This makes it possible to increase the detection sensitivity to sound emitted from the null point while reducing far-field noise. Furthermore, due to the delay of the output signal of the first microphone, a null point is formed at a position to cause the distances therefrom to the first and second microphones to be different from each other, so that the microphone unit of the present invention can be increased in an angular range of effective sensitivity. The microphone unit of the present invention takes advantage of a differential type microphone unit which has far-field noise reduction characteristics. In addition, even when the mouth of the talker (user) is positioned at a null point, the microphone unit of the present invention can minimize the reduction in the level of the voice of the talker due to the null point, making it possible to solve the problem of unrecognizable voice (extinction of voice). Particularly when mounted in a mobile phone, the microphone unit of the present invention can advantageously achieve good voice quality.

According to the microphone unit of the present invention, the delay means can be a delay element, or a propagation delay member for delaying the propagation of sound.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic perspective view of a microphone unit according to a first embodiment of the present invention;

FIG. 2 is a schematic block diagram of the microphone unit of the first embodiment;

Each of FIG. 3A and FIG. 3B is a graph showing relationship between an amount of delay and a null point in the microphone unit of the first embodiment;

FIGS. 4A to 4F are graphs in an angular coordinate system showing sensitivity characteristics, with various amounts of delay, of the microphone unit of the first embodiment to a far-field sound source at 500 mm;

FIGS. 5A to 5F are graphs in the angular coordinate system showing sensitivity characteristics, with various amounts of delay, of the microphone unit of the first embodiment to a near-field sound source at 25 mm;

FIG. 6 is a graph in a rectangular coordinate system showing sensitivity characteristics of the microphone unit of the first embodiment which correspond to those of FIGS. 5A to 5F, as obtained by superposing the curves of FIGS. 5A to 5F in the rectangular coordinate system;

FIG. 7 is a graph showing relationship between the amount of delay and gain reduction at a null point in the microphone unit of the first embodiment;

FIG. 8 is a graph showing relationship between the amount of delay and noise reduction effect in the microphone unit of the first embodiment;

FIG. 9 is a schematic front view showing an example of mounting the microphone unit of the first embodiment in a mobile phone;

FIG. 10 is a schematic cross-sectional view of a microphone unit of a second embodiment of the present embodiment;

FIG. 11 is a schematic cross-sectional view of a microphone unit of a third embodiment of the present embodiment;

FIG. 12 is a graph showing relationship between sound source distance and detection sensitivity in conventional differential type and non-directional microphone units; and

FIG. 13 is a schematic front view showing an example of mounting a conventional differential type microphone unit in a mobile phone.

### DESCRIPTION OF THE PREFERRED EMBODIMENTS

Embodiments of the present invention, as best mode for carrying out the invention, will be described hereinafter with reference to the drawings. The present invention relates to a microphone unit. It is to be understood that the embodiments herein are not intended as limiting, or encompassing the entire scope of, the invention. Note that like parts are designated by like reference numerals or characters throughout the drawings.

### First Embodiment

A microphone unit 1 according to a first embodiment of the present invention will be described with reference to FIG. 1 to FIG. 9. FIG. 1 is a schematic perspective view of the microphone unit 1 according to the first embodiment. The microphone unit 1 is mounted and used in a product such as a mobile phone or a hearing aid, and detects sound propagating in air (i.e. vibration of air), and further converts the detected sound to an electrical signal as an output signal. The microphone unit 1 comprises: a first microphone 2a and a second microphone 2b each for detecting sound and converting the detected sound to an electrical signal; a mounting base 10 for mounting the first and second microphones 2a, 2b; and so on. The microphone unit 1 is of a differential type to detect sound based on output signals of the first and second microphones 2a, 2b.

The first microphone 2a has a sound receiving portion 20a for receiving sound input therethrough, and converts the input sound to an electrical signal, and further outputs an electrical signal as an output signal having a phase and an amplitude corresponding to those (phase and amplitude) of the input sound. The second microphone 2b is similar to the first microphone 2a such that the second microphone 2b has a sound receiving portion 20b for receiving sound input therethrough, and converts the input sound to an electrical signal, and further outputs an electrical signal as an output signal having a phase and an amplitude corresponding to those (phase and amplitude) of the input sound. The first and second microphones 2a, 2b are mounted on the mounting base 10 (on one side of the mounting base) so that their sound receiving portions 20a, 20b face the same direction.

Each of the first and second microphones 2a, 2b has a capacitor formed by a vibratory diaphragm and a back electrode for sound detection, in which the vibratory diaphragm is vibrated by input sound, and the vibration of the vibratory diaphragm is detected by a change in electrostatic capacitance of the capacitor so as to detect the input sound and output an electrical signal as an output signal having a phase and an amplitude corresponding to those of the input sound. The vibratory diaphragm and the back electrode of each of the first and second microphones are formed as so-called MEMS (Micro Electro Mechanical System). More specifically, the vibratory diaphragm and the back electrode of each of the first and second microphones 2a, 2b are made by applying semiconductor fine processing technology, using silicon having conductivity (e.g. by ion injection or ion implantation). The first and second microphones 2a, 2b are called silicon microphones because the vibratory diaphragm and the back electrode are made of silicon. Due to the MEMS structure using silicon, it is possible to achieve a reduction in size and an increase in performance of the microphone unit 1.

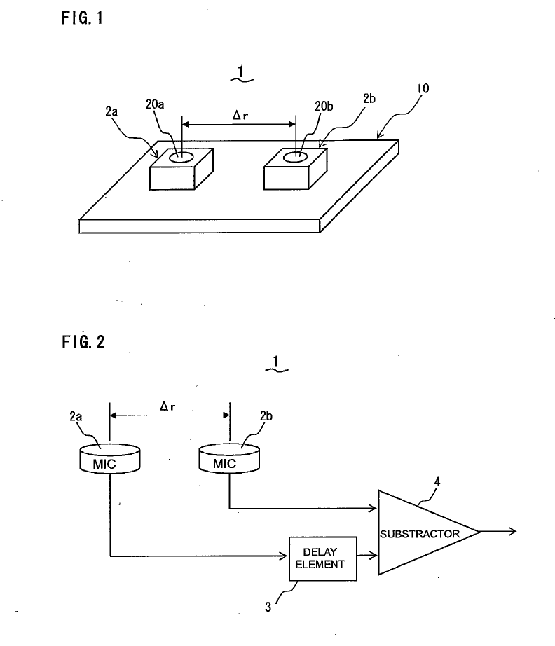

FIG. 2 is a schematic block diagram of the microphone unit 1. As shown in FIG. 2, the microphone unit 1 comprises in addition to the elements described above: a delay element 3 coupled to an output terminal of the first microphone 2a; a subtractor 4 coupled to an output terminal of the second microphone and an output terminal of the delay element 3; and so on. The delay element 3 of the microphone unit 1 serves to delay an input signal thereto, and receives the output signal of the first microphone 2a as an input signal here, so that the delay element 3 delays the output signal of the first microphone 2a for output. More specifically, the delay element 3 delays the output signal of the first microphone 2a so as to satisfy the relation 0.76≦D/Δr≦2.0 where D is amount of delay (delay time) for the output signal of the first microphone 2a while Δr is distance between the first and second microphones 2a, 2b (more specifically between the sound receiving portions 20a, 20b). Preferably, the distance Δr is 5 mm or shorter in order to effectively reduce omni-directional far-field noise. In the present embodiment, the distance is set at Δr=5 mm.

The subtractor 4 of the microphone unit 1 serves to calculate a difference, and output a difference signal, between the two input signals thereto, and here receives the output signal of the delay element 3, which is the output signal of the first microphone 2a delayed by the delay element 3, and the output signal of the second microphone 2b as input signals, so that the subtractor 4 outputs a difference signal between the output signal of the second microphone 2b and the output signal of the first microphone 2a delayed by the delay element 3. This difference signal between the two microphones 2a, 2b is output as an electrical signal of sound detected by the microphone unit 1.

In summary, when sound is input to the first and second microphones 2a, 2b of the microphone unit 1 with such a configuration, each of the first and second microphones 2a, 2b outputs an electrical signal having a phase and an amplitude corresponding to those of the sound input thereto. The output signal of the first microphone 2a is delayed by the delay element 3 and input to the subtractor 4, while the output signal of the second microphone 2b is input to the subtractor 4 without being delayed. Thus, the subtractor 4 outputs a difference signal between the output signal of the first microphone 2a delayed by the delay element 3 and the output signal of the second microphone 2b. In other words, the microphone unit 1 with the first and second microphones 2a, 2b, to both of which sound is input, detects the sound by a difference signal between the output signal of the first microphone 2a delayed by the delay element 3 (i.e. electrical signal delayed by the delay element 3 and having a phase and an amplitude corresponding to those of the sound input thereto) and the output signal of the second microphone 2b (i.e. electrical signal having a phase and amplitude corresponding to those of the sound input thereto without being delayed).

Each of FIG. 3A and FIG. 3B is a graph showing relationship between the amount of delay D (delay time of the output signal of the first microphone 2a delayed by the delay element 3) and a null point in the microphone unit 1. A null point is a position to cause the phase of an output signal of the first microphone 2a to be equal to that of the second microphone 2b when sound is emitted from such a position (position of a sound source). Thus, using the amount of delay D, the null point is defined as a position of a sound source where the difference between the sound propagation time therefrom to the first microphone 2a and that to the second microphone 2b is equal to the amount of delay D. In other words, assuming that Rd is propagation distance of sound corresponding to the amount of delay D, Ra is distance from a null point to the first microphone 2a, and Rb is distance from the null point to the second microphone 2b, then the position of the null point is such a position to cause the difference between the distances Ra and Rb to be Rd which is constant (Rd=Rb−Ra).

Referring to FIG. 3A, this will be described in detail below. In FIG. 3A, assuming that the positions of the first and second microphones 2a, 2b are Fa, Fb, respectively, and that the midpoint between the first and second microphones 2a, 2b is O, then the null point is at an arbitrary point P on a curved surface S as defined below. The curved surface S is a set (traces) of points P satisfying the equation Rd=Rb−Ra defining a rotational symmetry surface about a line segment L connecting the positions Fa, Fb as an axis, and has an apex So on the line segment L. The distance between the midpoint O and the apex So is (1/2)×Rd. The curvature of the curved surface S increases (decreases) with an increase (decrease) in the amount of delay D and in the distance of the apex So from the midpoint O. On the other hand, as shown in FIG. 3B, when the amount of delay D is 0 (zero), the null point is at an arbitrary point Q on a plane T which is a set (traces) of points Q satisfying the equation Rb−Ra=0. The plane T passes through the midpoint O and is perpendicular to the line segment L.

As described above, the microphone unit 1 of the present embodiment delays the output signal of the first microphone 2a so as to position the null point at such a position (position on the curves surface S) that the distances therefrom to the first and second microphones 2a, 2b are different from each other. This causes the sound emitted from the null point to propagate a distance to the first microphone 2a which is different from that to the second microphone 2b while spreading out spherically (thus attenuating the amplitude of the sound according to the propagation distance), so that the amplitude of the sound input to the first microphone 2a is different from that input to the second microphone 2b. Consequently, the output signals of the first and second microphones 2a, 2b based on the sound emitted from the null point are different in amplitude from each other. This difference in amplitude between the output signals of the first and second microphones 2a, 2b based on the sound emitted from the null point occurs even if the two output signals are equal to each other in phase. Thus, the sound emitted from the null point causes the difference between the two output signals, so that the sound emitted from the null point can be detected by using this difference between the two output signals.

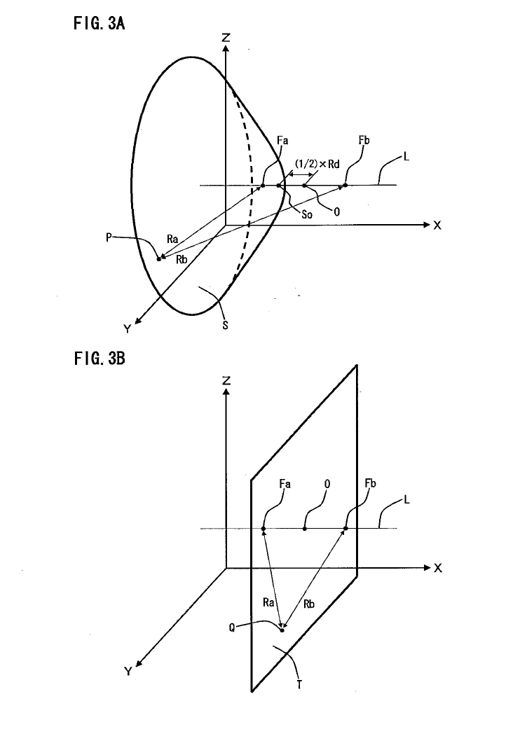

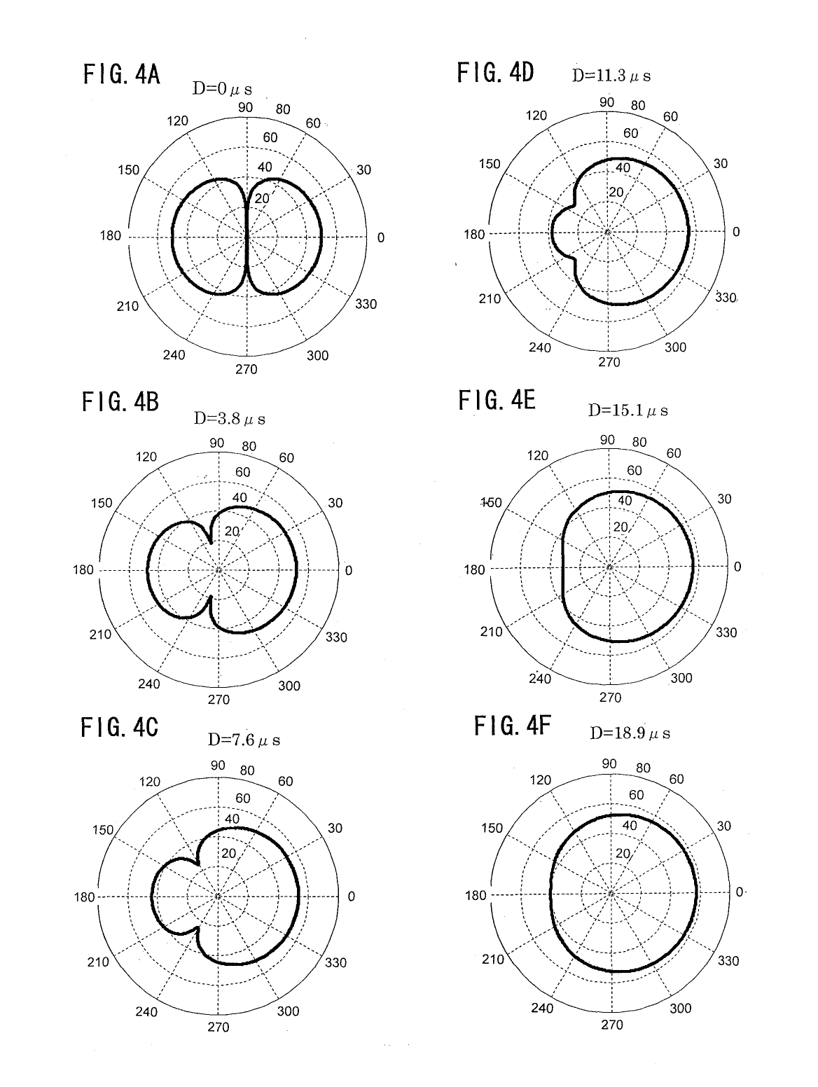

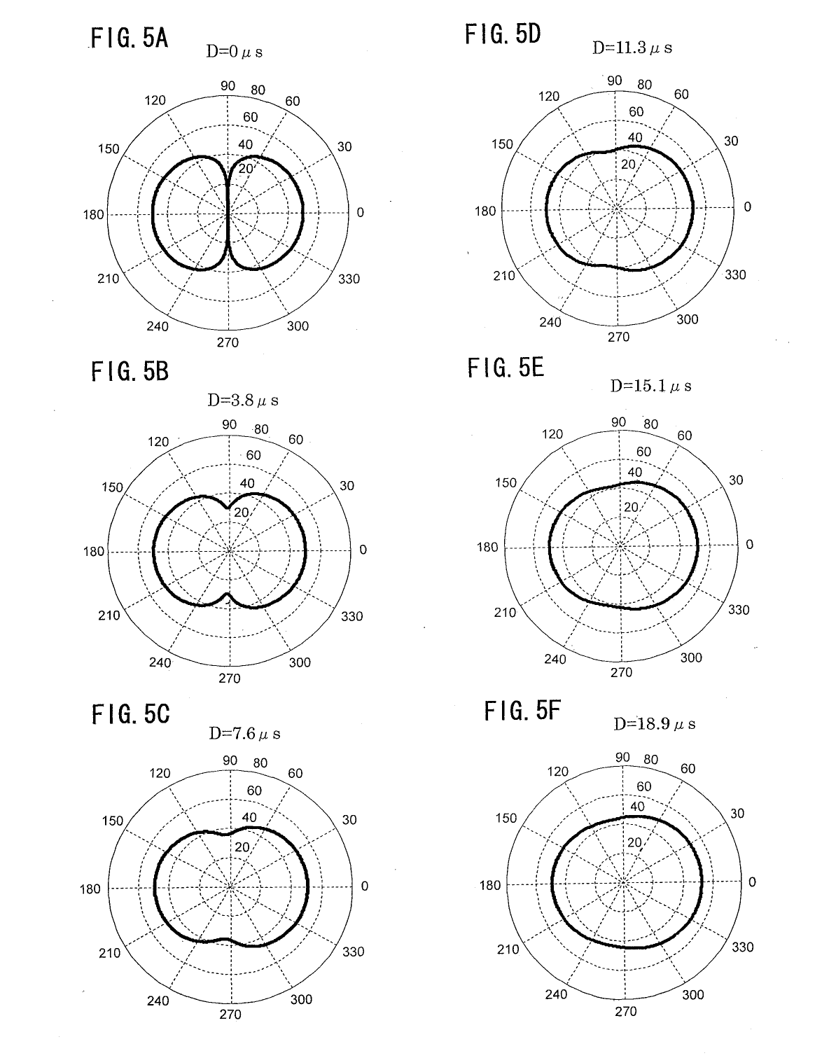

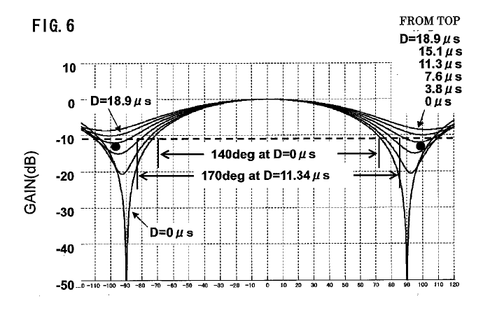

FIGS. 4A to 4F are graphs in an angular coordinate system showing sensitivity characteristics, with various amounts of delay D, of the microphone unit 1 of the present embodiment to a far-field sound source at 500 mm assuming far-field noise. On the other hand, FIGS. 5A to 5F are graphs in the angular coordinate system showing sensitivity characteristics, with various amounts of delay D, of the microphone unit 1 to a near-field sound source at 25 mm assuming a close talker. FIG. 6 is a graph in a rectangular coordinate system showing sensitivity characteristics of the microphone unit 1 which correspond to those of FIGS. 5A to 5F, as obtained by superposing the curves of FIGS. 5A to 5F in the rectangular coordinate system.

In FIGS. 4A to 4F and FIGS. 5A to 5F, the origin of the coordinate corresponds to the midpoint between the first and second microphones 2a, 2b of the microphone unit 1, and the 0° direction (zero degree) of the coordinate corresponds to the direction of the second microphone 2b as seen from the midpoint between the first and second microphones 2a, 2b. Note that in FIG. 6, each detection sensitivity (maximum sensitivity) to sound emitted from a position in the 0° direction in FIGS. 5A to 5F is shown as 0 (zero) dB. The sensitivity characteristics of the microphone unit 1 of the present embodiment shown in FIGS. 4A to 4F, 5A to 5F and 6 are those obtained by setting the distance Δr between the first and second microphones 2a, 2b at Δr=5 mm and the frequency of the sound at 1 kHz which is the fundamental frequency of the human voice.

As apparent from FIGS. 4A to 4F, in the case of the far-field sound source at 500 mm assuming far-field noise, a null point occurs at a position in the 90° direction and the 270° direction (i.e. position equidistant to the first and second microphones 2a, 2b) at an amount of 0 μs of delay D, and the position of the null point changes when the amount of delay D is added. As the amount of delay D increases, the null point moves farther away from the 90° and 270° directions and closer to the 180° direction. Furthermore, at an amount of 0 μs of delay D, the detection sensitivity to the sound emitted from the null point is 0 (zero). The detection sensitivity thereto increases as the amount of delay D increases, while the amount of reduction in the detection sensitivity, relative to the maximum sensitivity (detection sensitivity to the sound emitted from a position in the 0° direction), to the sound emitted from the null point decreases.

Further, as apparent from FIGS. 5A to 5F and 6, also in the case of the near-field sound source at 25 mm assuming a close talker, a null point occurs at a position in the 90° direction and the 270° direction at an amount of 0 μs of delay D, and the position of the null point changes when the amount of delay D is added. As the amount of delay D increases, the null point moves farther away from the 90° and 270° directions and closer to the 180° direction. Furthermore, at an amount of 0 μs of delay D, the detection sensitivity to the sound emitted from the null point is 0 (zero). The detection sensitivity thereto increases as the amount of delay D increases, while the amount of reduction in the detection sensitivity, relative to the maximum sensitivity (detection sensitivity to the sound emitted from a position in the 0° direction), to the sound emitted from the null point decreases. Defining the angular range of detection sensitivity from the maximum sensitivity (detection sensitivity to the sound emitted from a position in the 0° direction) to −10 dB as an angular range of effective sensitivity, the angular range of effective sensitivity is 140° at an amount of 0 μs of delay D. The angular range of effective sensitivity increases as the amount of delay D increases, and the angular range of effective sensitivity is 170° at an amount of 11.3 μs of delay D.

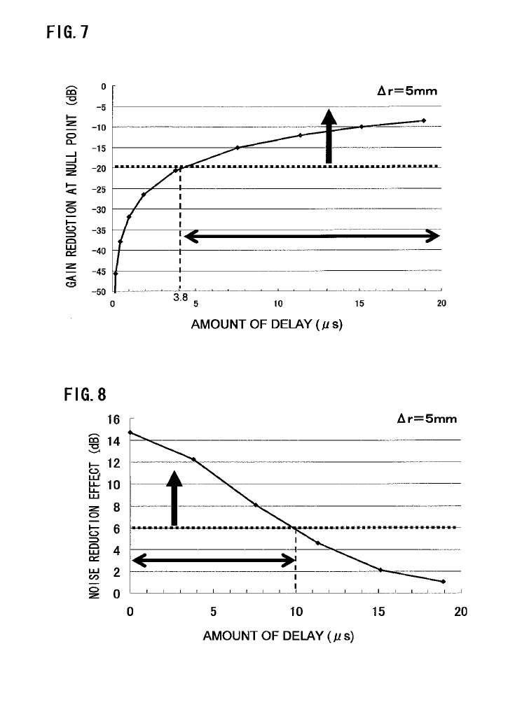

FIG. 7 is a graph showing relationship between the amount of delay D and gain reduction at a null point in the microphone unit 1 in the case of the near-field sound source at 25 mm assuming a close talker. Here, the gain reduction at a null point means a reduction in the detection sensitivity, relative to the maximum sensitivity, to sound emitted from the null point, indicating that as the gain reduction at a null point decreases, the detection sensitivity to sound emitted from the null point increases. FIG. 7 shows a variation of the gain reduction at the null point with a variation of the amount of delay D, in which the horizontal axis is the amount of delay D, and the vertical axis is the gain reduction at the null point. Note that the absolute value of the vertical axis indicates an amount of gain reduction at the null point, indicating that as the absolute value of the vertical axis decreases, the gain reduction at the null point decreases.

The gain reduction at the null point in the microphone unit 1 shown here in FIG. 7 is a result which is obtained based on the results shown in FIGS. 5A to 5F and FIG. 6 described above. Thus, it is a result obtained by using the microphone unit 1 of the present embodiment in which the distance Δr between the first and second microphones 2a, 2b is set at Δr=5 mm, and the frequency of the sound is set at 1 kHz which is the fundamental frequency of the human voice. The gain reduction at the null point is required to be 20 dB or less from a practical point of view, or more specifically, to allow a user to easily listen to and recognize the sound in view of human auditory perception.

It can be understood from the result shown in FIG. 7 that a smaller (larger) amount of delay D causes an increase (decrease) in the gain reduction at a null point. A result was obtained that the gain reduction at the null point is 20 dB or less when the amount of delay D is 3.8 μs or larger. Generalizing the amount of delay D and the distance Δr (=5 mm) between the first and second microphones 2a, 2b by dividing D by Δr, the obtained result indicates that the gain reduction at the null point is 20 dB or less if D/Δr (μs/mm) is 0.76 or higher. Similar results were obtained, indicating that even when the distance Δr between the first and second microphones 2a, 2b of the microphone unit 1 of the present embodiment is set at 2 mm or 10 mm, the gain reduction at the null point is 20 dB or less if D/Δr (μs/mm) is 0.76 or higher. From these results, it is derived that D/Δr (μs/mm) is required to be 0.76 or higher in order to increase the detection sensitivity to sound emitted from the position of a null point by preventing the gain reduction at the null point from a practical point of view (the relation 0.76≦D/Δr allowing such increase in the detection sensitivity by preventing such gain reduction).

FIG. 8 is a graph showing relationship between the amount of delay D and noise reduction effect in the microphone unit 1. Here, the noise reduction effect means an effect to reduce far-field noise (reduce the detection sensitivity to sound emitted from a position at a far distance), and more specifically corresponds to the difference between detection sensitivity to sound from a position at a near distance and that from a position at a far distance. In a general non-directional microphone unit, sound is detected based on an output signal of a single microphone with no noise reduction effect, so that the difference between the former detection sensitivity (to detect sound such as a talking voice which needs to be detected) and the latter detection sensitivity (to detect sound which is not required to be detected) is small. In contrast, in the microphone unit of the present embodiment, the difference between the former and latter detection sensitivities is superior to that in the general non-directional microphone unit as apparent from FIG. 8.

FIG. 8 shows results of measurements of the noise reduction effect which were actually made by varying the amount of delay D, in which the horizontal axis is amount of delay D while the vertical axis is noise reduction effect, indicating that as the value of the vertical axis increases, the noise reduction effect increases. Note that the measurements of the noise reduction effect were made by using the microphone unit 1 of the present embodiment in which the distance Δr between the first and second microphones 2a, 2b is set at Δr=5 mm, and also a conventional non-directional microphone for comparison, and by placing the microphone units in an actual noise environment.

Note that the noise reduction effect is required to be 6 dB or more from a practical point of view, more specifically, to allow a user to feel in view of human auditory perception that the noise is effectively reduced. It can be understood from the results of actual measurements shown in FIG. 8 that a smaller (larger) amount of delay D causes an increase (decrease) in the noise reduction effect. A result of actual measurement was obtained that a noise reduction effect of 6 DB or more can be obtained when the amount of delay D is 10 μs or smaller. Generalizing the amount of delay D and the distance Δr (=5 mm) between the first and second microphones 2a, 2b by dividing D by Δr, the obtained result of actual measurement indicates that a noise reduction effect of 6 DB or more can be obtained if D/Δr (μs/mm) is 2.0 or lower. Similar results of actual measurements were obtained, indicating that even when the distance Δr between the first and second microphones 2a, 2b of the microphone unit 1 of the present embodiment is set at 2 mm or 10 mm, the noise reduction effect is 6 dB or more if D/Δr (μs/mm) is 2.0 or lower. From these results, it is derived that D/Δr (μs/mm) is required to be 2.0 or lower in order to obtain a noise reduction effect to reduce far-field noise from a practical point of view (the relation D/Δr≦2.0 allowing such noise reduction effect to reduce far-field noise).

As understood from the above, in the microphone unit 1 of the present embodiment, it is important to allow the delay element 3 to delay the output signal of the first microphone 2a by an amount of delay D which satisfies the relation 0.76≦D/Δr≦2.0. The microphone unit 1 of the present embodiment makes it possible to reduce far-field noise based on the relation D/Δr≦2.0, while it can increase the detection sensitivity to sound emitted from the position of a null point based on the relation 0.76≦D/Δr. Thus, the microphone unit 1 of the present embodiment can increase the detection sensitivity to sound emitted from the null point, while reducing far-field noise, by delaying the output signal of the first microphone 2a by an amount of delay D which satisfies the relation 0.76≦D/Δr≦2.0.

As described above, according to the microphone unit 1 of the present embodiment, the amount of delay D of the output signal of the first microphone 2a causes the position of a null point to be differently distanced from the first and second microphones 2a, 2b. In order to determine an angular range of effective sensitivity in this regard, actual measurements were also made by placing the microphone unit 1 at various positions to measure the detection sensitivities to sound emitted from the position of a null point and from positions other than the position of the null point. The results of the actual measurements indicate that the sound emitted from the positions other than the position of the null point can be detected at high sensitivity. This indicates that the microphone unit 1 of the present embodiment can have an increased angular range of effective sensitivity.

As described in the foregoing, the microphone unit 1 of the present embodiment makes it possible to increase the detection sensitivity to sound emitted from a null point, while reducing far-field noise, and increase the angular range of effective sensitivity. In other words, the microphone unit 1 of the present embodiments takes advantage of a differential type microphone unit which has far-field noise reduction characteristics, and at the same time solves the problem of voice level reduction at a null point. More specifically, even when the mouth of the talker (user) is positioned at a null point, the microphone unit 1 can minimize the reduction in the level of the voice of the talker due to the null point, making it possible to solve the problem of unrecognizable voice (extinction of voice). Particularly when mounted in a mobile phone, the microphone unit 1 can advantageously achieve good voice quality.

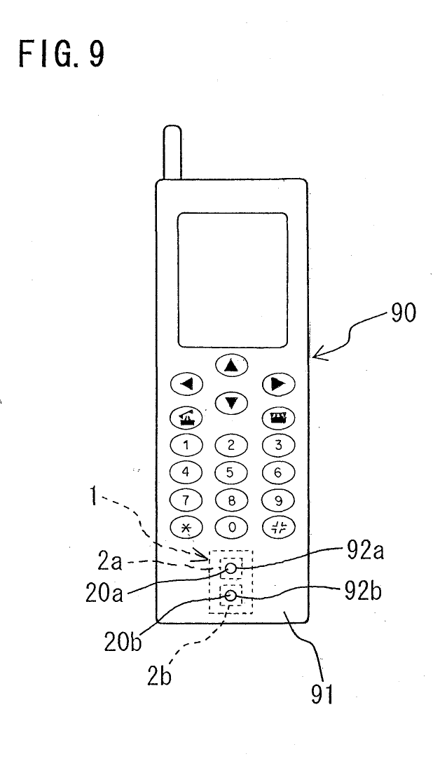

FIG. 9 is a schematic front view showing an example of mounting the microphone unit 1 of the present embodiment in a mobile phone 90. Referring to FIG. 9, the microphone unit 1 of the present embodiment is mounted, for example, in a mobile phone 90 having housing 91 which has sound receiving openings 92a, 92b formed on one side thereof (facing a user or talker), while the first and second microphones 2a, 2b has sound receiving portions 20a, 20b, respectively, which face the sound receiving openings 92a, 92b, respectively, and are placed on the same side on which the sound receiving openings 92a, 92b are placed. When the microphone unit 1 is mounted in the mobile phone 90 in this manner, null points occur in the direction of the talker (on the talker side). Even when mounted in the mobile phone 90 in this manner (even when a null point occurs in the direction of the talker), the microphone unit 1 of the present embodiment can increase the detection sensitivity to sound emitted from the null point, and increase the angular range of effective sensitivity, making it possible to solve the problem of unrecognizable voice (extinction of voice) and achieve good voice quality.

### Second Embodiment

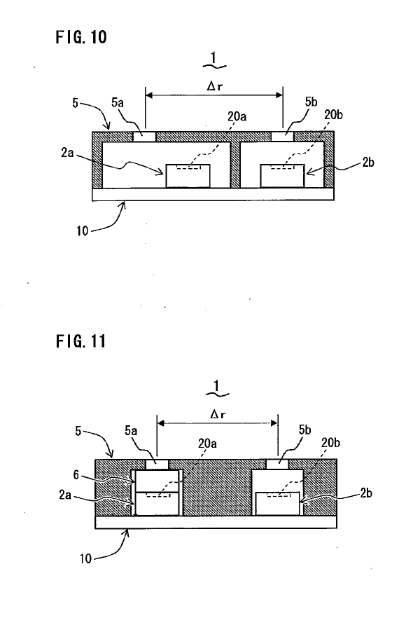

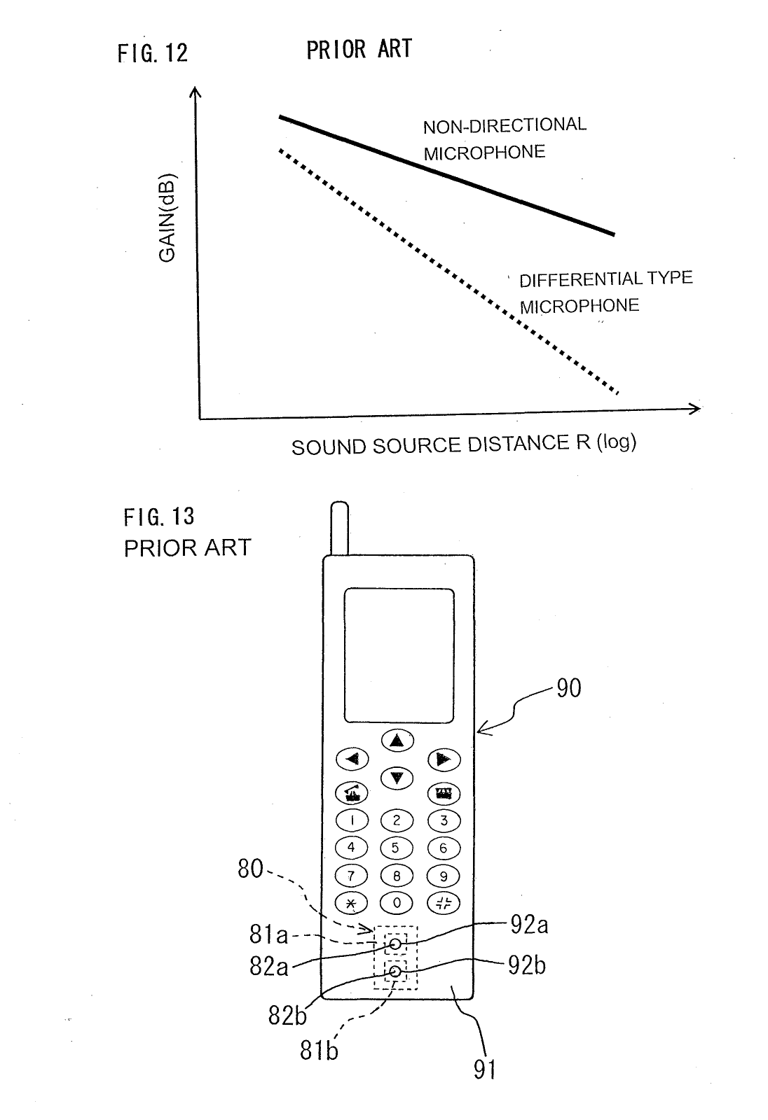

A microphone unit 1 according to a second embodiment of the present invention will be described with reference to FIG. 10, which is a schematic cross-sectional view of a microphone unit 1 of the present embodiment. The microphone unit 1 of the present embodiment is the same as that of the first embodiment, except that it further comprises a cover 5 for covering a first microphone 2a and a second microphone 2b, and that it does not comprise a delay element 3 used in the first embodiment. More specifically, the microphone unit 1 of the present embodiment detects the sound by a difference signal between an output signal of the first microphone 2a (i.e. electrical signal having a phase and an amplitude corresponding to those of the sound input thereto without being delayed) and an output signal of the second microphone 2b (i.e. electrical signal having a phase and an amplitude corresponding to those of the sound input thereto without being delayed).

The cover 5 has an end (ends of the standing walls) connected to the entire peripheral end of a mounting base 10 for mounting the first and second microphones 2a, 2b. The cover 5 has first and second openings 5a, 5b for allowing sound to be input therethrough. The first and second openings 5a, 5b are formed in a top wall of the cover 5, i.e. on the same plane of the cover 5 (i.e. on the same plane of the microphone unit 1). Here, the distance (length of sound propagation path) from the first opening 5a to the first microphone 2a (sound receiving portion 20a) is made different from the distance (length of sound propagation path) from the second opening 5b to the second microphone 2b (sound receiving portion 20b) so that the former distance is longer than the latter distance. The difference between the distance from the first opening 5a to the first microphone 2a and that from the second opening 5b to the second microphone 2b causes a difference between the sound propagation time from the first opening 5a to the first microphone 2a and the sound propagation time from the second opening 5b to the second microphone 2b. According to the present embodiment, this difference in time is used to position a null point at such a position that the distances therefrom to the first opening 5a (first microphone 2a) and the second opening 5b (second microphone 2b) are different from each other.

Now, assume that Δr is distance between the first opening 5a and the second opening 5b, while D is difference in time between the sound propagation time from the first opening 5a to the first microphone 2a and the sound propagation time from the second opening 5b to the second microphone 2b. In the present embodiment, the difference in distance between the distance from the first opening 5a to the first microphone 2a and the distance from the second opening 5b to the second microphone 2b is selected or designed to cause a difference in time D which satisfies the relation 0.76≦D/Δr≦2.0. Preferably, the distance Δr is 5 mm or shorter in order to effectively reduce omni-directional far-field noise. In the present embodiment, the distance is set at Δr=5 mm. Since the difference in time D functions in the same manner as the amount of delay D in the first embodiment, it is understood that the difference in time D can also be referred to as amount of delay D. The microphone unit 1 of the present embodiment has similar functions and effects to those of the microphone unit of the first embodiment.

### Third Embodiment

A microphone unit 1 according to a third embodiment of the present invention will be described with reference to FIG. 11, which is a schematic cross-sectional view of a microphone unit 1 of the present embodiment. The microphone unit 1 of the present embodiment is the same as that of the first embodiment, except that it further comprises a cover 5 for covering a first microphone 2a and a second microphone 2b, and a propagation delay member 6 for delaying the propagation of sound, and that it does not comprise a delay element 3 used in the first embodiment. The cover 5 has an end (ends of the standing walls) connected to the entire peripheral end of a mounting base 10 for mounting the first and second microphones 2a, 2b. The cover 5 has a first opening 5a and a second opening 5b for allowing sound to be input therethrough. The first and second openings 5a, 5b are formed in a top wall of the cover 5, namely on the same plane of the cover 5 (i.e. on the same plane of the microphone unit 1). Here, the distance from the first opening 5a to the first microphone 2a (sound receiving portion 20a) is made equal to the distance from the second opening 5b to the second microphone 2b (sound receiving portion 20b).

The propagation delay member 6 is formed, for example, of a material such as felt, and delays sound (delays sound propagation) without attenuating the amplitude of the sound. The propagation delay member 6 is provided between the first opening 5a and the first microphone 2a (i.e. in the sound propagation path from the first opening 5a to the first microphone 2a). The provision of the propagation delay member 6 between the first opening 5a and the first microphone 2a causes a difference in time between the sound propagation time from the first opening 5a to the first microphone 2a and the sound propagation time from the second opening 5b to the second microphone 2b. According to the present embodiment, this difference in time is used to position a null point at such a position that the distances therefrom to the first opening 5a (first microphone 2a) and the second opening 5b (second microphone 2b) are different from each other.

Now, assume that Δr is distance between the first opening 5a and the second opening 5b, while D is difference in time between the sound propagation time from the first opening 5a to the first microphone 2a and the sound propagation time from the second opening 5b to the second microphone 2b. In the present embodiment, the propagation delay member 6 is selected or designed to satisfy the relation 0.76≦D/Δr≦2.0. Preferably, the distance Δr is 5 mm or shorter in order to effectively reduce omni-directional far-field noise. In the present embodiment, the distance is set at Δr=5 mm. Since the difference in time D functions in the same manner as the amount of delay D in the first embodiment, it is understood that the difference in time D can also be referred to as amount of delay D. The microphone unit 1 of the present embodiment has similar functions and effects to those of the microphone unit of the first embodiment.

It is to be noted that the present invention is not limited to the above embodiments, and various modifications are possible within the spirit and scope of the present invention. For example, in the first embodiment described above, it is possible to delay the output signal of the second microphone by a delay element instead of delaying the output signal of the first microphone by the delay element. Furthermore, in the first embodiment, it is also possible to use, instead of the delay element, a propagation delay member (formed, for example, of a material such as felt) for delaying the sound propagation, and place the propagation delay member on the sound receiving portion of the first or second microphone. Such an arrangement also makes it possible to obtain similar functions and effects as obtained in the first embodiment.

In addition, in the first to third embodiments, each of the first and second microphones to be used is not limited to one formed by a vibratory diaphragm and a back electrode as a MEMS (silicon microphone), but can be of an electret capacitor type in which the vibratory diaphragm is formed of an electret diaphragm (dielectric body with residual polarization). Further, it can be a microphone of an electrodynamic type, an electromagnetic type, or a piezoelectric (crystal) type. Moreover, in the second and third embodiments, the first and second openings 5a, 5b can be formed on different planes of the cover (different planes of the microphone unit). Such an arrangement also makes it possible to obtain similar functions and effects as in the second and third embodiments.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2009-049921 filed Mar. 3, 2009, the content of which is hereby incorporated by reference.

What is claimed is:

1. A microphone unit comprising:
a first microphone and a second microphone for converting sound to electrical signals as output signals so as to detect the sound based on the output signals of the first and second microphones; and
delay means for delaying the output signal of the first microphone,
wherein the delay means delays the output signal of the first microphone so as to satisfy relation 0.76≦D/Δr≦2.0 where D is amount of delay for the output signal of the first microphone while Δr is distance between the first and second microphones, and
wherein the sound is detected by a difference signal between the output signal of the first microphone delayed by the delay means and the output signal of the second microphone.

2. The microphone unit according to claim 1, wherein the delay means is a delay element.

3. The microphone unit according to claim 1, wherein the delay means is a propagation delay member for delaying the propagation of sound.
